(19) United States
(12) Patent Application Publication
(10) Pub. No.: US 2011/0300827 A1
(43) Pub. Date: Dec. 8, 2011

(54) Method and Apparatus of Determining a Minimum Data Rate and a Number of Target Users for a Cellular Radio System

(75) Inventors: Rong Hu, Sollentuna (SE); Feng Zhu, Beijing (CN)

(73) Assignee: Telefonaktiebolaget LM Ericsson (publ), Stockholm (SE)

(21) Appl. No.: 13/202,284

(22) PCT Filed: Feb. 19, 2009
(86) PCT No.: PCT/SE2009/050187

§ 371 Date: Aug. 18, 2011

(51) Int. Cl. H04M 11/00

(52) U.S. Cl. 455/405

(57) ABSTRACT

In a method for setting a minimum rate and number of target users for a cell served by a NodeB of a cellular radio system, the maximum value of target users and minimum rate are determined during a cell planning phase.

### TECHNICAL FIELD

The present invention relates to a method and a device for providing improved performance in a cellular radio system.

### BACKGROUND

Recently, minimum data rates or Quality of Service (QoS) for some target users have been introduced by some providers of mobile services. For example, different guaranteed bit rates are for “gold”, “silver” and “bronze” users. Consequently, a novel High-Speed Downlink Packet Access (HSDPA) scheduler is expected to guarantee data rates of some target users to be higher than a desired minimum rate. This new HSDPA scheduler achieves the minimum rate without Radio resource Management (RRM) functions of admission control, congestion control or dropping and similar.

In Jonas Olsson: “Performance impact of introducing higher bit-rate streaming over HS-DSCH in a WCDMA mixed traffic scenario”, EAB/TB-04:000053, December 2004 HSDPA scheduling impact on stream and web mixed traffic scenario is studied. Scheduling priorities are computed differently for different services according to each different minimum rate, and streaming priority is usually set much higher than web priority. As a result, streaming users often take resources from web users. However, for a single traffic scenario, the method does not work. In addition, the dropping function was enabled in Jonas Olsson: “Performance impact of introducing higher bit-rate streaming over HS-DSCH in a WCDMA mixed traffic scenario”, EAB/TB-04:000053, December 2004.

In Patrick A. Hosein, “Qos Control in WCDMA HSDPA”, September 2002, the 4th IEEE Conference on Mobile and Wireless Communication Networks; a Barrier-Proportional Fair (B-PF) scheduler in HSDPA is described. The paper describes a procedure where the SINR difference is manually set between gold users and silver users in the simulation, which is not realistic in reality.

It has been observed that the minimum rate scheduling is at the cost of cell throughput (system capacity) compared with proportional fair scheduling, and too high minimum rate and too large number of target users would decrease system capacity largely without achieving minimum rate for target users. The existing solutions fail to provide an efficient method for setting a minimum rate and number of target users.

Hence, there exist a need for a method and a system that is able to provide an efficient method for setting a minimum rate and number of target users.

### SUMMARY

It is an object of the present invention to overcome or at least reduce some of the problems associated with providing an efficient method for setting a minimum rate and number of target users, which guarantees the Quality of Service (QoS) for the target users.

This object and others are obtained by the method and system as set out in the appended claims. Thus, by determining both minimum rate and number of target users during a network dimensioning and planning phase, the minimum rate and number of target users can be set in a more efficient manner without suffering from the drawbacks of existing methods for setting a minimum rate and number of target users. In order to get individual user data rate, geometry factors on some traffic scenarios can be collected and used for determining individual data rates.

In accordance with one embodiment the maximum value of target users and minimum rate can be determined by estimating the user individual data rate in typical user position and a given traffic scenario.

In accordance with one embodiment individual data rate for a User Equipment can be determined by first measuring a cell geometry factor in a typical position for given traffic scenario for the User Equipment. Then input parameters for the User Equipment is collected and finally, and the individual rate for the User Equipment is determined based on the collected input parameters.

In accordance with one embodiment a possible target user number and/or target user position distributions are selected during determination of the maximum value of users and minimum rate.

In accordance with one embodiment, the outcome of a determined maximum value of users and minimum rate is checked against one or many criteria set for the system performance, thereby ensuring that the system criteria are met.

When an individual user rate is generated, the minimum rate and number of target users can be set based on the individual user rate.

Hereby an efficient method for determined maximum value of users and minimum rate settings is obtained that enables system operators to guarantee certain minimum performance levels in the system to a particular user.

The invention also extends to a node, in particular a node B, in a cellular radio system adapted to perform procedural steps in accordance with the above.

### BRIEF DESCRIPTION OF THE DRAWINGS

The present invention will now be described in more detail by way of non-limiting examples and with reference to the accompanying drawings, in which:

FIG. 1 is a view of a cellular radio system, and

FIG. 2 is a view illustrating procedural steps performed when determining a minimum rate and a number of target users.

### DETAILED DESCRIPTION

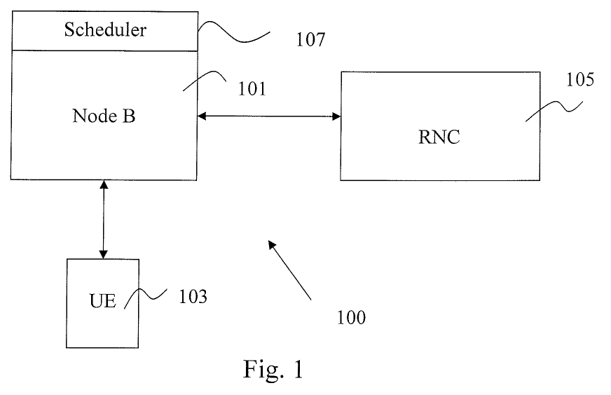

In FIG. 1 a view of a cellular radio system 100 is shown. The system can for example be a system employing Wideband Code Division Multiple Access (WCDMA) and using High Speed Packet Access (HSPA), in particular High Speed Downlink Packet Access (HSDPA). The system 100 comprises a base station (Node B) 101. The base station 101 serves a number of mobile terminals, usually termed User Equipment (UE) 103, located within the area/cell covered by the base station 101. The base station 101 is also connected to a radio network controller node (RNC) 105. The system 100 also comprises a scheduler 107 for scheduling traffic to and from the UEs of the cell served by the base station 101. The unit 107 is typically co-located or an integral part of the base station 101.

Assuming there are K users in a cell and N users are target users for minimum rate, the scheduler 107 can in accordance with one embodiment be adapted to ensure minimum rate rₘ for N target users. The scheduler 107 then uses a proportional fair scheduling for all K users. The scheduling can be described as:

If any r̅ₙ(t)<rₘ(n=1, Λ, N), only schedule target user

$${max}_{n} \frac{1}{{\overline{r}}_{n} ( t )} ( n = 1 , Λ , N ) ,$$

else, schedule all users as

$${max}_{k} \frac{{r}_{k} ( t )}{{\overline{r}}_{k} ( t )} ( k = 1 , Λ , K )$$

Where r̅ᵢ(t) and rₖ(t) are average rate and instantaneous of user i at time t, respectively.

In accordance with one embodiment at a full-buffer scenario without code multiplexing, there are K users in a cell, and N (N≦K) users are target users for minimum rate rₘ. In the below description it is assumed that every user has the time-invariant data rate to radio base station NodeB no matter what interference changes and channel fades.

These N target users have the individual rate r₁,r₂,Λr_{N}. The individual rate is defined as the rate of single user per cell, that is to say the user is always scheduled. For convenience, all rates here are data rate per Transmission Tome Interval (TTI).

The minimum mean rate and number of target users should meet the formula below:

$${r}_{m} \leq 1 / ( {\sum }_{n = 1}^{N} \frac{1}{{r}_{n}} )$$

In accordance with one embodiment individual user rates in a deployed network can be generated in three steps: The three steps can for a given User Equipment (UE) be:

Step 1: measure a cell geometry factor in a typical position for given traffic scenario for the UE.

Step 2: collect input parameters, such as cell power, code and UE category for the UE.

Step 3: determine the individual rate for the UE based on the collected input parameters.

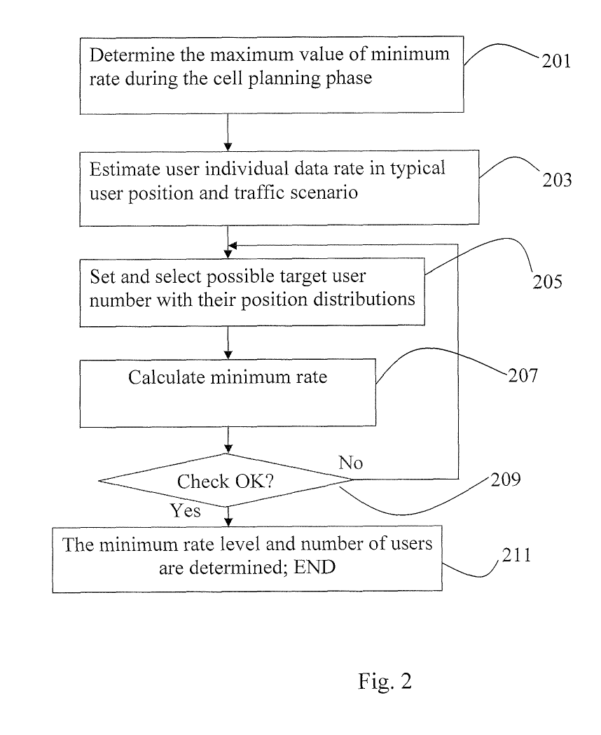

In FIG. 2 a flow chart illustrating an exemplary procedure for providing a minimum rate configuration is shown. First in a step 201, the maximum value of users and minimum rate is determined during the cell planning phase. The maximum value of users and minimum rate can be determined by applying the following steps. First, in a step 203, the user individual data rate in typical user position and a given traffic scenario is estimated. This can for example be performed as described above. Next, in a step 205, possible target user number along with their position distributions are set and selected. Thereupon, in a step 207, the minimum rate is calculated. The minimum rate can be calculated as described above. Next, in a step 209, the result is checked against one or many criteria set for the system performance such as system capacity loss, the promised user rate of the operator etc. If the check in step 209 results in that one or many criteria is not met, the procedure returns to step 205. If all criteria in step 205 are met the procedure continues to a step 211. In step 211, the minimum rate level and number of users are determined.

Using the method and scheduler as described herein will enable operators of cellular radio systems to promise a certain Quality of service (QoS) for one or several users without degrading system performance below a determined level or failing to deliver an agreed minimum data rate.

1-9. (canceled)

10. A method of setting a minimum rate and a maximum number of target users for a cell served by a NodeB of a cellular radio system, the method comprising:
estimating an individual data rate for a user equipment based on at least one input parameter collected for a typical position and a given traffic scenario of the user;
determining a preliminary number of target users and a preliminary minimum rate during a cell planning phase based on the estimated user individual data rate;
determining at least one system performance parameter based on the preliminary number of target users and the preliminary minimum rate; and
if each of the at least one performance parameter satisfies a corresponding performance criteria, setting the minimum rate and the maximum number of target users to the preliminary minimum rate and the preliminary number of target users, respectively.

11. The method according to claim 10, further comprising if one or more of the at least one performance parameters fails to satisfy the corresponding performance criteria, repeating the estimating and determining steps to determine at least one new system performance parameter based on a new preliminary number of targets and a new preliminary minimum rate.

12. The method according to claim 10, wherein estimating the user individual data rate further comprises:
measuring a cell geometry factor in the typical position for the given traffic scenario for the user equipment; and
collecting the input parameters for the user equipment associated with the measured cell geometry factor.

13. The method according to of claim 10, wherein the at least one input parameter comprises at least one of a cell power a code, and a user equipment category.

14. The method according to claim 10, wherein the performance criteria comprise at least one of a system capacity loss and a promised user rate.

15. A node for use in a cellular radio system, the node configured to:
estimate an individual data rate for a user based on at least one input parameter collected for a typical position and a given traffic scenario of a user equipment;
determine preliminary number of users and a preliminary minimum rate during a cell planning phase based on the estimated user individual data rate;
determine at least one system performance parameter based on the preliminary number of target users and the preliminary minimum rate; and
if each of the at least one performance parameter satisfies a corresponding performance criteria, setting the minimum rate and the maximum number of target users to the preliminary minimum rate and the preliminary number of target users, respectively.

16. The node according to claim 15, wherein the node is further configured to, if one or more of the at least one performance parameters fails to satisfy the corresponding performance criteria, repeat the estimating and determining elements to determine at least one new system performance parameter based on a new preliminary number of targets and a new preliminary minimum rate.

17. The node according to claim 15, further configured to:
measure a cell geometry factor in the typical position for the given traffic scenario for the user equipment; and
collect the input parameters for the user equipment associated with the measured cell geometry factor.

18. The node according to claim 15, wherein the at least one input parameter comprises at least one of a cell power a code, and a user equipment category.

19. The node according to claim 15, wherein the performance criteria comprise at least one of a system capacity loss and a promised user rate.
